(19) United States
(12) Patent Application Publication
(10) Pub. No.: US 2010/0027717 A1
(43) Pub. Date: Feb. 4, 2010

(54) Equalization of OFDM Signals Based on Time and Then Frequency Interpolation

(75) Inventors: Lekun Lin, Milpitas, CA (US); Sheng Lin, Milpitas, CA (US); Kai Xie, Milpitas, CA (US)

Correspondence Address: FENWICK & WEST LLP, SILICON VALLEY CENTER, 801 CALIFORNIA STREET, MOUNTAIN VIEW, CA, 94041, US

(73) Assignee: REDDOT WIRELESS, INC., Milpitas, CA (US)

(21) Appl. No.: 11/831,364

(22) Filed: Jul. 31, 2007

(51) Int. Cl. H04L 27/06

(52) U.S. Cl. 375/340

(57) ABSTRACT

Two dimensional interpolation techniques are used to compensate for time-varying channel gain H in an OFDM system. The channel gain can be reasonably estimated at various times and at various frequencies due, for example, to the use of pilot tones. These channel estimates are used to estimate the channel gain at other times and/or frequencies by two-dimensional interpolation, interpolating first with respect to time (e.g., with respect to a symbol index s) and then with respect to frequency (e.g., with respect to a sub-carrier index c).

### BACKGROUND

1. Field of Art

The present invention generally relates to the field of equalization in wireless communication systems, and more specifically, to equalization in systems based on orthogonal frequency-division multiplexing (OFDM) and/or orthogonal frequency division multiple access (OFDMA).

2. Description of the Related Art

Many communication systems transmit information by modulating a carrier signal according to properties of a data stream. One commonly used modulation scheme is orthogonal frequency-division multiplexing (OFDM). ODFM divides the data stream to be transmitted into several parallel data sub-streams, each containing a portion of the data in the original stream. The available transmission frequency spectrum is also divided into sub-carriers at different frequencies. Each of the data sub-streams is transmitted on one of the sub-carriers using a conventional modulation scheme such as phase-shift-keying (PSK), binary phase-shift-keying (BPSK) or quadrature amplitude modulation (QAM) to modulate the sub-carrier.

OFDM is widely used in modern communication systems because it does not require complex filters to compensate for sub-optimal channel conditions, such as multipath interference or narrowband interference. This has resulted in widespread use of OFDM in wideband digital communication systems such as asynchronous digital subscriber line (ADSL) networks or networks compliant with the IEEE 802.11a/b standard, the IEEE 802.16 standard or the IEEE 802.20 standard.

When multiple users share a communications system, there must also be some mechanism to allocate the capacity of the communications system among the users. Orthogonal frequency-division multiple access (OFDMA) is a multiple-access/multiplexing scheme that can be used to allocate capacity among many users for a communications system based on OFDM. In OFDMA, certain sub-carriers are allocated to each user for certain time periods. The sub-carriers allocated to a user may or may not be adjacent to each other in frequency, thus increasing the frequency diversity and resistance to frequency-specific effects.

OFDMA is often used for wireless systems, including for example WiMAX (IEEE 802.16e). Mobility can be a major feature for these systems. However, mobility introduces fast channel fading. That is, the transfer function of the channel H(s,c), where s is the symbol index (i.e., time index) and c is the sub-carrier index (i.e., frequency index), can vary rapidly over time for any given sub-carrier c. A conventional equalizer (such as one based on MMSE—minimum mean squared error) is typically used to estimate and compensate for variations in the channel gain H(s,c). However, MMSE based equalizers require the correlations between different sub-carriers, which may not be available in real applications.

Thus, there is a need for an approach to channel compensation that is fast enough to use in mobile applications and preferably does not require correlations between different sub-carriers.

### SUMMARY

Various embodiments of the invention allow wireless communication systems to compensate for variations in the channel gain H(s,c) based on estimates of the channel gain Ĥ(s,c) that are determined in two dimensions as follows. Assume that channel estimates Ĥₚ(sₚ,cₚ) are known or can be reliably determined for certain positions of (s,c), where the subscript p indicates that these estimates are reliable. Now assume that a channel estimate is desired for (s₀,c₀). The reliable channel estimates Ĥₚ(sₚ,cₚ) are first used to determine a set of channel estimates Ĥₚₓ(s₀,cₚ) at the desired time index: Ĥ(s₀,cₚ). These estimates Ĥₚₓ(s₀,cₚ) are then used to determine the channel estimate at the correct frequency index: Ĥ(s₀,c₀).

In one approach, interpolation is used to determine the estimates. For each given cₚ, the reliable channel estimates Ĥₚ(sₚ,cₚ) are interpolated in s to yield Ĥₚₓ(s₀,cₚ). The channel estimates Ĥₚₓ(s₀,cₚ) are then interpolated in c to yield Ĥ(s₀,c₀). That is, the reliable channel estimates Ĥₚ(sₚ,cₚ) are interpolated first in time (e.g., with respect to the symbol index s) and then in frequency (e.g., with respect to the sub-carrier index c). The channel estimates Ĥ(s,c) can be used to compensate for variations in the channel gain H(s,c).

In one implementation, the transmission scheme specifies that pilot tones are located at given positions of (sₚ,cₚ). The channel gain is estimated for these positions based on the received pilot tones, and these channel estimates form the set of reliable channel estimates Ĥₚ(sₚ,cₚ). The reliable channel estimates are then used to perform a two-dimensional interpolation to estimate the channel gain Ĥ(s,c) at the other positions of (s,c), specifically at the positions that are used for data transmission. In this implementation, the two-dimensional interpolation is separable in s and c, meaning that a one-dimensional interpolation in s is first performed, followed by a one-dimensional interpolation in c.

In a variation of this approach, the transmission scheme groups the sub-carriers into “clusters.” For example, in parts of the WiMAX standard, fourteen contiguous sub-carriers are grouped into a single cluster. Channel estimation then occurs within that cluster since it is not known whether other clusters will be active.

Other aspects of the invention include devices that implement channel estimation techniques such as those described above, components for these devices, and systems using these devices or techniques. Further aspects include methods and processes corresponding to all of the foregoing.

### BRIEF DESCRIPTION OF DRAWINGS

The disclosed embodiments have other advantages and features which will be more readily apparent from the following detailed description and the appended claims, when taken in conjunction with the accompanying drawings, in which:

FIG. 1 is a block diagram of a data communication network suitable for use with the invention.

FIG. 2 is a block diagram of a transceiver according to one embodiment of the invention.

FIG. 3 is a block diagram of a receive data path according to one embodiment of the invention.

FIG. 4 is a diagram illustrating an example cluster structure.

FIGS. 5a and 5b illustrate channel estimation for odd and even symbols, respectively.

### DETAILED DESCRIPTION

The Figures and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention. It is noted that wherever practicable similar or like reference numbers may be used in the figures and may indicate similar or like functionality.

Generally, the following examples allow channel estimation in OFDM and/or OFDMA systems by interpolating channel estimates at some positions of (s,c) to other positions of (s,c), typically by interpolating first in time (or symbol) and then interpolating in frequency (or sub-carrier).

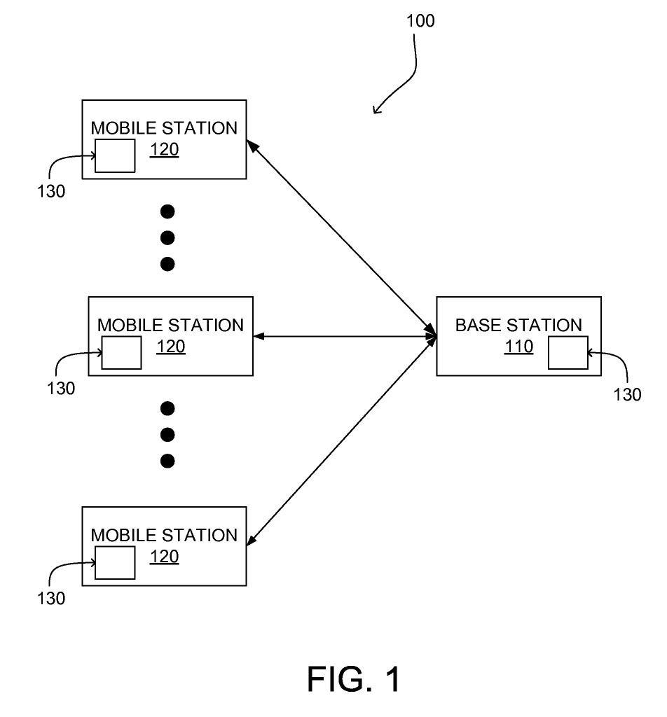

FIG. 1 shows a data communication network 100 suitable for use with the invention. The data communication network 100 includes a base station 110 and one or more mobile stations 120 (i.e., mobile communication devices). The base station 110 and mobile stations 120 include transceivers 130 for wirelessly transmitting and receiving data between the devices. In some applications, the data communication network 100 is a wireless network compliant with the IEEE 802.16 standard, the IEEE 802.11 standard or the IEEE 802.20 standard. For convenience, FIG. 1 shows transceivers 130 but devices 110 and 120 could be configured with only transmitters or only receivers if bidirectional communication is not required.

The data communication network 100 typically uses symbols to represent data to be transmitted and uses multicarrier modulation to transmit the symbols. For example, the data communication network 100 could transmit data symbols using orthogonal frequency-division multiplexing (OFDM), binary phase-shift keying (BPSK), or other modulation methods. Multicarrier modulation techniques, such as ODFM, divide the data stream to be transmitted into several parallel data sub-streams, each containing less data than the original data stream. The available frequency spectrum is also divided into several sub-carriers used to transmit each reduced data stream using a modulation scheme such as BPSK, phase-shift-keying (PSK), quadrature amplitude modulation (QAM) or another suitable modulation technique to modulate each sub-carrier.

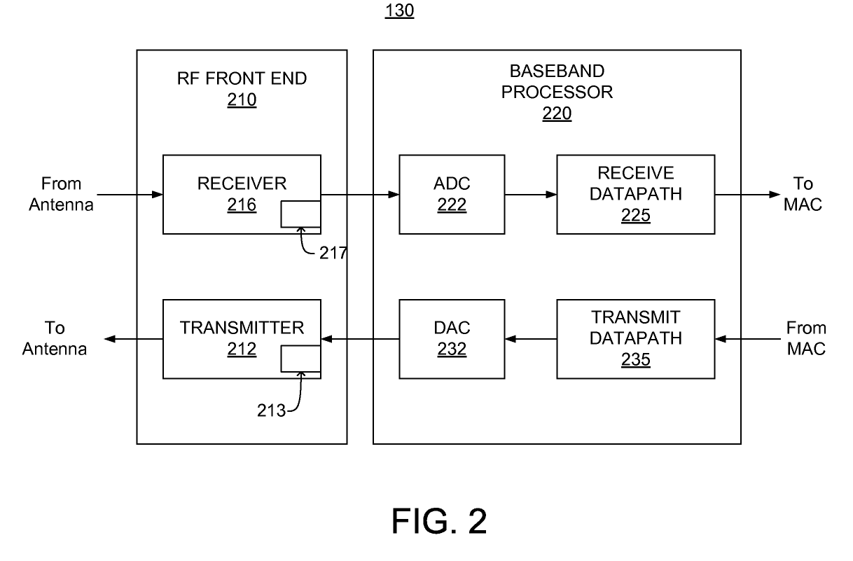

The base station 110 and mobile station 120 include transceivers 130 for transmitting and receiving wireless communications signals that contain these data symbols. The transceiver 130 transmits wireless communication signals and receives wireless communication signals to be processed from other devices. In certain applications, the transceiver 130 includes an antenna capable of transmitting and receiving wireless signals, such as those compliant with the IEEE 802.16 standard, IEEE 802.11a/b/g standard or other wireless communication formats. However, the transceiver 130 can be any device capable of wirelessly transmitting and receiving signals. Digital techniques simplify the radio frequency (RF) components of the transceiver 130. A more detailed description of the structure of the transceiver 130 is provided in conjunction with FIG. 2.

In the example of FIG. 2, the transceiver 130 includes an RF antenna (not shown in FIG. 2), an RF front end 210 and a baseband processor 220. The baseband processor 220 interfaces to a media access control (MAC) subsystem (not shown).

In the receive direction, the RF front end 210 includes a receiver 216 and the baseband processor 220 includes an analog-to-digital converter (ADC) 222 and a receive datapath 225. The receiver 216 receives RF signals from other devices using wireless communication techniques. The receiver includes a demodulator 217 which extracts data from the incoming modulated signal by correlating changes in input signal characteristics, such as amplitude, phase and frequency, with data symbols. In some implementations, the demodulator 217 is implemented as part of the baseband processor 220. Depending on the type of modulation scheme, such as OFDM, OFDMA, PSK or other suitable scheme, the demodulator 217 performs different actions to extract the symbols from the carrier signal. The baseband processor 220 processes the symbols recovered by the RF front end 210. The ADC 220 converts analog signals received by the receiver 216 to digital signals. The receive datapath 225 processes these digital signals, converting them to data bits for the MAC subsystem.

In the reverse, transmit direction, the baseband processor 220 includes a transmit data path 235 and a digital to analog converter (DAC) 232. The RF front end 210 includes a transmitter 212. The receive data path 235 converts incoming data into symbols, which are converted to analog form by the DAC 232. The transmitter 212 uses a modulator 213 to modulate a carrier signal responsive to the symbols received from the baseband processor 220.

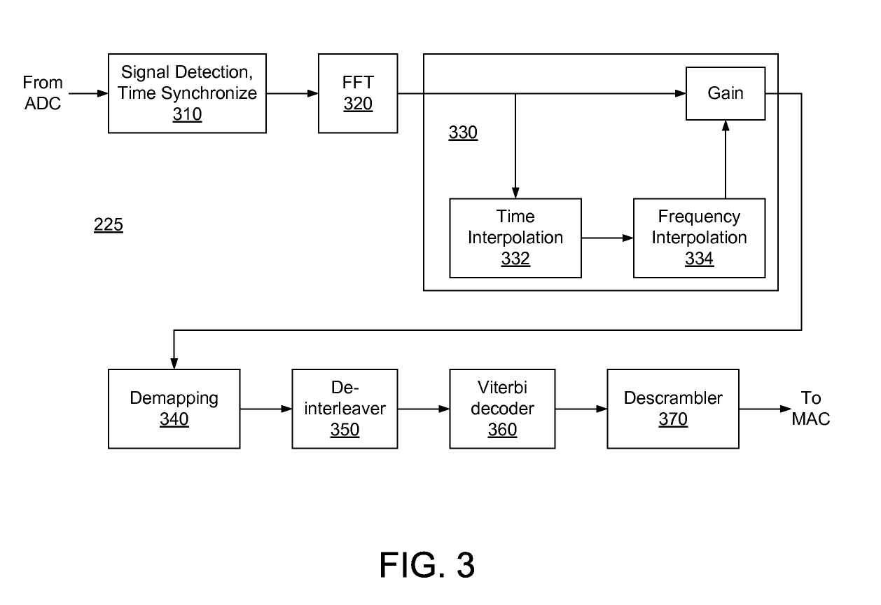

FIG. 3 is a block diagram of a receive data path 225 according to one embodiment of the invention. In this example, the receive data path 225 includes a module 310 for signal detection and timing synchronization, an FFT 320, a module 330 for channel compensation, a demapping module 340, a de-interleaver 350, a Viterbi decoder 360 and a de-randomizer (descrambler) 370.

When transceiver 130 receives data, the channel compensator 330 compensates for effects due to variations in the communications channel. These effects can be modeled as a channel transfer function H(s,c) where s is a symbol index and c is a sub-carrier index. H(s,c) can be thought of as the channel gain for symbol s located at sub-carrier frequency c. Unlike conventional compensators that are based on MMSE or other types of equalization, the channel compensator 330 produces an estimate Ĥ(s,c) of the transfer function by first interpolating the received symbols with respect to time (i.e., with respect to s) and then with respect to frequency (i.e., with respect to c). The channel estimate Ĥ(s,c) can then be used to provide appropriate compensation for the symbols. In the example of FIG. 2, the gain applied to a symbol at position (s,c) varies depending on the channel estimate Ĥ(s,c). The channel estimates Ĥ(s,c) can also be used in the transmit direction to precorrect (i.e., apply pre-emphasis) to the transmit signal.

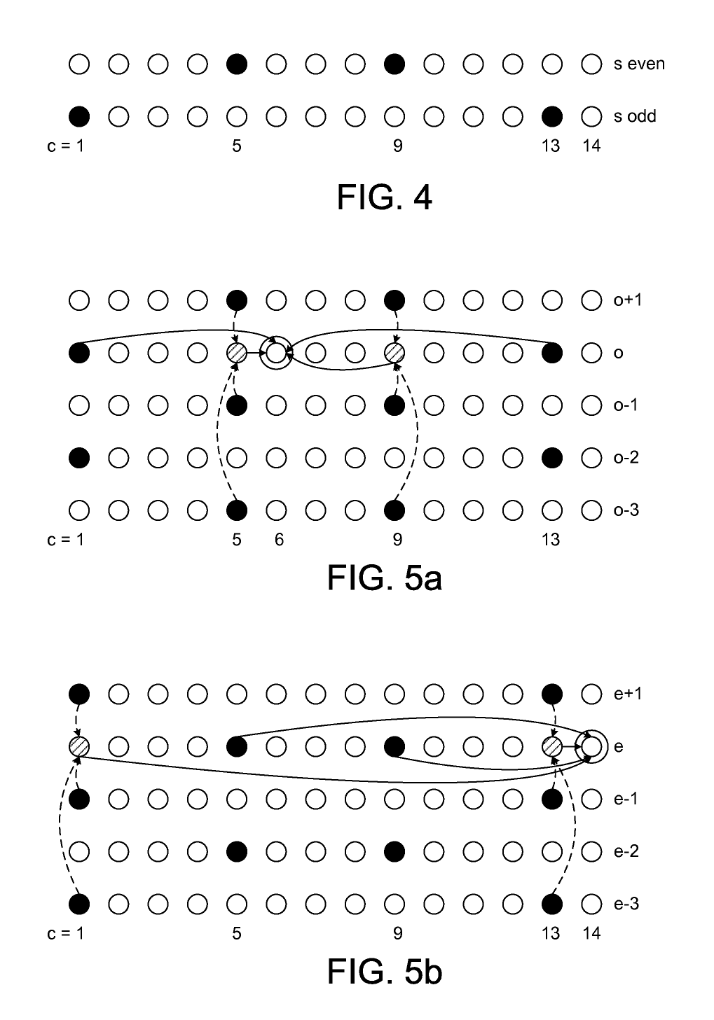

FIGS. 4-5 show an example based on the WiMAX standard. In the WiMAX standard, the system capacity is subdivided into clusters. FIG. 4 shows the cluster structure for the downlink fully used sub-carrier case (DL PUSC). The cluster contains 14 contiguous sub-carriers, which will be referred to here as sub-carriers c=1 to 14. For odd-numbered symbols, sub-carriers 1 and 13 are specified to be pilot tone sub-carriers, which are indicated by solid circles in FIG. 4. For even-numbered symbols, sub-carriers 5 and 9 are specified to be pilot tone sub-carriers. The remaining symbols can be used for data transmission.

For convenience, the notation (o, c) will be used to refer to positions where the symbol index s is odd. Similarly, the notation (e, c) will be used to refer to positions where the symbol index s is even. Thus, positions (o,1), (o,13), (e,5) and (e,9) contain pilot tones. These positions will also be indicated by the subscript p. For example, the notation (sₚ,cₚ) may be used to refer to the positions that contain pilot tones. Since positions (o,1), (o,13), (e,5) and (e,9) contain pilot tones, the channel estimates Ĥ(o,1), Ĥ(o,13), Ĥ(e,5) and Ĥ(e,9) can be fairly reliably determined. This set of channel estimates will be denoted as Ĥₚ or Ĥₚ(sₚ,cₚ). Given set of reliable channel estimates Ĥₚ(sₚ,cₚ), the channel estimate Ĥ(s,c) can be interpolated for other positions of (s,c). In the interpolation, it is preferable to first interpolate with respect to s and then with respect to c.

FIGS. 5a and 5b show two examples for estimating the values of Ĥ(o,6) and Ĥ(e,14), respectively. These Figures shows several symbols before and after the desired symbol o or e, respectively. As in FIG. 4, the solid circles indicate a pilot tone. In FIG. 5a, the channel estimate Ĥ(o,6) is desired, as indicated by the double circle. For that symbol o, the reliable channel estimates are the pilot tone channel estimates Ĥₚ(o,1) and Ĥₚ(o,13). For convenience, these pilot tone channel estimates will be referred to as on-symbol estimates because they are directly available for the symbol o. Thus, Ĥₚ(o,1) and Ĥₚ(o,13) are on-symbol pilot tone channel estimates for symbol o and Ĥₚ(e,5) and Ĥₚ(e,9) are on-symbol pilot tone channel estimates for symbol e. Ĥ(o,6) could be estimated by interpolating the two on-symbol pilot tone channel estimates Ĥₚ(o,1) and Ĥₚ(o,13), but interpolation based on only two values is not very accurate.

It would be desirable to have more on-symbol estimates on which to base the interpolation, but only two pilot tone estimates are available for symbol o. This deficiency is overcome by interpolating the off-symbol estimates with respect to s in order to estimate Ĥₚᵢ(o,5) and Ĥₚᵢ(o,9). The subscript pi indicates that these channel estimates are not direct pilot tone channel estimates but are “indirect” in the sense that they are based on off-symbol pilot tone channel estimates. In this particular example, three values are interpolated to provide each of these estimates. Specifically, Ĥₚ(o−3,5), Ĥₚ(o−1,5) and Ĥₚ(o+1,5) are interpolated to estimate Ĥₚᵢ(o,5), as shown by the dashed arrows and the cross-hatch of Ĥₚᵢ(o,5). Similarly, Ĥₚ(o−3,9), Ĥₚ(o−1,9) and Ĥₚ(o+1,9) are interpolated to estimate Ĥₚᵢ(o,9). The four pilot tone-based channel estimates Ĥₚ(o,1), Ĥₚᵢ(o,5), Ĥₚᵢ(o,9) and Ĥₚ(o,13) are then interpolated to estimate Ĥ(o,6), as indicated by the solid arrows. In this particular example, Lagrange interpolation is used.

FIG. 5b shows a similar approach for estimating Ĥ(e,14). In this example, Ĥₚ(e,5) and Ĥₚ(e,9) are on-symbol channel estimates. Ĥₚᵢ(e,1) and Ĥₚᵢ(e,13) are estimated by interpolating the off-symbol pilot tone channel estimates Ĥₚ(e−3,1), Ĥₚ(e−1,1), Ĥₚ(e+1,1) and Ĥₚ(e−3,13), Ĥₚ(e−1,13), Ĥₚ(e+1,13), respectively. The four pilot tone-based channel estimates Ĥₚᵢ(e,1), Ĥₚ(e,5), Ĥₚ(e,9) and Ĥₚᵢ(e,13) are then interpolated to estimate Ĥ(e,14).

FIG. 5 is merely an example and other variations will be apparent. For example, interpolation other than Lagrange interpolation and/or based on different numbers of points can also be used. In addition, not all off-symbol estimates need be determined. In FIG. 5a, channel estimate Ĥ(o,6) could be based on the two on-symbol estimates Ĥₚ(o,1) and Ĥₚ(o,13) and only one “indirect” pilot tone-based channel estimate, either Ĥₚᵢ(o,5) or Ĥₚᵢ(o,9). Alternately, it could be based solely on linear interpolation between Ĥₚᵢ(o,5) and Ĥₚᵢ(o,9) since c=6 is located between c=5 and c=9. Extending this concept across the entire range of c yields a piece-wise linear interpolation of Ĥ(s,c). Channel estimates can be based on other combinations of some or all of the pilot tone-based estimates Ĥₚ(o,1), Ĥₚᵢ(o,5), Ĥₚᵢ(o,9) and Ĥₚ(o,13). For example, channel estimate Ĥ(o,5) could be based solely on the interpolation in s of the off-symbol pilot tone channel estimates Ĥₚ(e,5).

As another example, the initial interpolation in s may be eliminated if there are sufficient on-symbol pilot tone channel estimates. In the example of FIG. 5, there are only two on-symbol pilot tone channel estimates for each symbol and this generally is not enough to provide a sufficiently accurate estimate for data positions. However, if there had been three or four on-symbol pilot tone channel estimates, the initial estimation of Ĥₚᵢ(o,5) and Ĥₚᵢ(o,9) based on off-symbol pilot tone estimates could be avoided.

In another variation, estimation can be based on positions outside the cluster. In FIG. 5b, the position (e,14) is not bounded by two pilot tone estimates and, therefore, is more susceptible to inaccurate interpolation (interpolation is meant to include extrapolation). Thus, Ĥ(e,14) could be estimated based on channel estimates from the adjacent cluster (e.g., using Ĥₚᵢ(e,1) and/or Ĥₚ(e,5) from the immediately adjacent cluster), assuming that the adjacent cluster is active. If not active, there may be no pilot tone available in the adjacent cluster.

Finally, the above discussion introduced general principles in the context of determining a single channel estimate. Thus, if only Ĥ(o,5) were desired then there might not be any need to interpolate the Ĥₚ(e,9) estimates to determine Ĥₚᵢ(o,9). However, in practice, it is usually desirable to estimate the channel gain for all positions of (s,c) within a cluster. If a cluster is allocated to a user, then all positions within that cluster typically will be utilized and it would be beneficial to estimate Ĥ for all c=1 to 14 in this example.

In that case, one approach is to determine all pilot tone channel estimates (whether directly for on-symbol pilot tones or indirectly by interpolation for off-symbol pilot tones) for each symbol index s, and then to use these pilot tone channel estimates to determine the channel estimates for all other sub-carriers c. Referring to FIG. 3, the time interpolation module 332 would determine pilot tone-based channel estimates Ĥₚₓ(s,1), Ĥₚₓ(s,5), Ĥₚₓ(s,9) and Ĥₚₓ(s,13) for all symbols s. Here, the subscript px indicates that the channel estimate may be either an on-symbol pilot tone channel estimate (subscript p) or may be a channel estimate based on off-symbol pilot tone estimates (subscript pi). The frequency interpolation module 334 would then estimate the remaining channel gains Ĥ(s,c) for non-pilot tone sub-carrier frequencies c. In another approach, the initial channel estimate can be based in whole or in part on the preamble (i.e., the first symbol(s) of a frame).

The interpolation modules 332 and 334, and channel compensation module 330 can be implemented in many ways. For example, they may be implemented as a software process and/or a firmware application structured to operate on a general purpose microprocessor or controller, a field programmable gate array (FPGA), an application specific integrated circuit (ASIC) or a combination thereof.

As used herein, “coupled” is intended to mean both coupled directly (without intervening elements) and coupled indirectly (with intervening elements). Upon reading this disclosure, those of skill in the art will appreciate still additional alternative structural and functional designs for a system and a method for estimating and compensating for channel gain through the disclosed principles herein. Thus, while particular embodiments and applications have been illustrated and described, it is to be understood that the present invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. In a receiver for receiving wireless communications using OFDM/OFDMA, a method for determining channel estimates Ĥ(s₀,c) at a symbol index s₀ for a set of sub-carriers c, comprising:
determining pilot tone-based channel estimates Ĥₚₓ(s₀,cₚ) for at least two pilot tone sub-carriers cₚ, wherein determining the pilot tone-based channel estimate Ĥₚₓ(s₀,cₚ) for at least one of the pilot tone sub-carriers cₚ comprises:
determining off-symbol pilot tone channel estimates Ĥₚ(s,cₚ) where s≠s₀; and
determining the pilot tone-based channel estimate Ĥₚₓ(s₀,cₚ) based on the off-symbol pilot tone channel estimates Ĥₚ(s,cₚ); and
determining the channel estimates Ĥ(s₀,c) for non-pilot tone sub-carriers c based on the pilot tone-based channel estimates Ĥₚₓ(s₀,cₚ).

2. The method of claim 1 wherein the step of determining the pilot tone-based channel estimate Ĥₚₓ(s₀,cₚ) based on the off-symbol pilot tone channel estimates Ĥₚ(s,cₚ) where s≠s₀ comprises interpolating the off-symbol pilot tone channel estimates Ĥₚ(s,cₚ) to determine the pilot tone-based channel estimate Ĥₚₓ(s₀,cₚ).

3. The method of claim 2 wherein the step of interpolating uses Lagrange interpolation.

4. The method of claim 2 wherein the step of interpolating is based on a larger number of previous off-symbol pilot tone channel estimates Ĥₚ(s,cₚ) with s<s₀ than later off-symbol pilot tone channel estimates Ĥₚ(s,cₚ) with s>s₀.

5. The method of claim 2 wherein the step of interpolating is based on one previous off-symbol pilot tone channel estimate Ĥₚ(s,cₚ) with s<s₀ and on one later off-symbol pilot tone channel estimate Ĥₚ(s,cₚ) with s>s₀.

6. The method of claim 1 wherein determining the channel estimates Ĥ(s₀,c) for non-pilot tone sub-carriers c based on the pilot tone-based channel estimates Ĥₚₓ(s₀,cₚ) comprises interpolating the pilot tone-based channel estimates Ĥₚₓ(s₀,cₚ) to determine the channel estimates Ĥ(s₀,c).

7. The method of claim 6 wherein the step of interpolating uses Lagrange interpolation.

8. The method of claim 6 wherein the step of interpolating uses piece-wise linear interpolation.

9. The method of claim 1 wherein, for each symbol index s₀, the step of determining pilot tone-based channel estimates Ĥₚₓ(s₀,cₚ) comprises determining on-symbol pilot tone channel estimates Ĥₚ(s₀,cₚ) for not more than two pilot tone sub-carriers cₚ.

10. The method of claim 1 wherein the sub-carriers c are sub-carriers for an OFDMA cluster; the step of determining pilot tone-based channel estimates Ĥₚₓ(s₀,cₚ) for at least two pilot tone sub-carriers cₚ comprises determining pilot tone-based channel estimates Ĥₚₓ(s₀,cₚ) for all pilot tone sub-carriers cₚ within the cluster; and the step of determining the channel estimates Ĥ(s₀,c) for non-pilot tone sub-carriers c comprises determining the channel estimates Ĥ(s₀,c) for all non-pilot tone sub-carriers c within the cluster.

11. The method of claim 10 wherein, for each symbol index s₀, the step of determining pilot tone-based channel estimates Ĥₚₓ(s₀,cₚ) comprises determining on-symbol pilot tone channel estimates Ĥₚ(s₀,cₚ) for not more than two pilot tone sub-carriers cₚ.

12. The method of claim 10 wherein the step of determining the pilot tone-based channel estimate Ĥₚₓ(s₀,cₚ) based on the off-symbol pilot tone channel estimates Ĥₚ(s,cₚ) where s≠s₀ comprises determining the pilot tone-based channel estimate Ĥₚₓ(s₀,cₚ) based on not more than three off-symbol pilot tone channel estimates Ĥₚ(s,cₚ).

13. The method of claim 10 wherein, for odd symbol indices, the cluster contains not more than two pilot tones and, for even symbol indices, the cluster contains not more than two pilot tones which are located at different sub-carriers than for the odd symbol indices.

14. The method of claim 10 wherein the cluster structure complies with the WiMAX standard.

15. The method of claim 10 wherein
the step of determining the pilot tone-based channel estimate Ĥₚₓ(s₀,cₚ) based on the off-symbol pilot tone channel estimates Ĥₚ(s,cₚ) where s≠s₀ comprises interpolating the off-symbol pilot tone channel estimates Ĥₚ(s,cₚ) to determine the pilot tone-based channel estimate Ĥₚₓ(s₀,cₚ); and
the step of determining the channel estimates Ĥ(s₀,c) for non-pilot tone sub-carriers c based on the pilot tone-based channel estimates Ĥₚₓ(s₀,cₚ) comprises interpolating the pilot tone-based channel estimates Ĥₚₓ(s₀,cₚ) to determine the channel estimates Ĥ(s₀,c).

16. The method of claim 1 wherein the steps of determining pilot tone-based channel estimates Ĥₚₓ(s₀,cₚ) and determining the channel estimates Ĥ(s₀,c) for non-pilot tone sub-carriers c occur within a mobile receiver.

17. A receiver for receiving wireless communications using OFDM, comprising a channel compensation module that compensates for effects due to a channel transfer function H(s,c) where s is a symbol index and c is a sub-carrier index, the channel compensation module comprising:
a first module that determines pilot tone-based channel estimates Ĥₚₓ(s₀,cₚ) for at least two pilot tone sub-carriers cₚ, wherein for at least one of the pilot tone sub-carriers cₚ, the first module determines off-symbol pilot tone channel estimates Ĥₚ(s,cₚ) where s≠s₀ and determines the pilot tone-based channel estimate Ĥₚₓ(s₀,cₚ) based on the off-symbol pilot tone channel estimates Ĥₚ(s,cₚ); and
a second module coupled to the first module, the second module determining the channel estimates Ĥ(s₀,c) for non-pilot tone sub-carriers c based on the pilot tone-based channel estimates Ĥₚₓ(s₀,cₚ).
